(19) United States
(12) Patent Application Publication
(10) Pub. No.: US 2025/0353948 A1
(43) Pub. Date: Nov. 20, 2025

(54) POLYMER HAVING ALDEHYDE GROUPS

(71) Applicant: SIKA TECHNOLOGY AG, Baar (CH)

(72) Inventors: Andreas KRAMER, Zürich (CH); Urs BURCKHARDT, Zürich (CH); Ursula STADELMANN, Zürich (CH)

(73) Assignee: SIKA TECHNOLOGY AG, Baar (CH)

(21) Appl. No.: 18/874,160

(22) PCT Filed: Jun. 21, 2023
(86) PCT No.: PCT/EP2023/066810

§ 371 Date: Dec. 12, 2024

(30) Foreign Application Priority Data
Jul. 13, 2022 (EP) 22184830.2

(51) Int. Cl. C08G 18/00

(52) U.S. Cl. CPC C08G 18/006

(57) ABSTRACT

A non-ionic aldehyde-functional polymer with end groups of formula (I) and an average content of aldehyde groups of 0.15 to 1.2 meq/g. The polymer is suitable for cross-linking compounds with reactive groups such as more particularly cyanoacetate groups, acetoacetate groups or malonate groups at ambient temperatures. It permits a particularly long processing time with fast curing and elastic products that have particularly high tensile strength and tear propagation resistance at high extensibility. It is therefore suitable as a component of elastic adhesives, sealants or coatings that are largely free of toxic ingredients, have low sensitivity to moisture and blistering, have particularly good processability and are particularly robust and durable.

### TECHNICAL FIELD

The invention relates to polymers having aldehyde groups and to the use thereof for curing of compounds having reactive groups such as, in particular, cyanoacetate, acetoacetate or malonate groups, and to room temperature curable adhesives, sealants or coatings.

### PRIOR ART

Reactive polymer compositions that are curable at room temperature and can be used as adhesives, sealants or coatings with elastic properties are known. Polyurethane systems that cure through the reaction of isocyanate groups with polyols and/or moisture and form particularly highly elastic polymers are in widespread use. However, these are sensitive to bubble formation as a result of excess moisture in the course of curing, and the polyisocyanates used for the purpose are usually toxic compounds. Reactive polymer compositions based on silane-functional polymers (SMP/STP) and silicones are also in widespread use. In the course of curing thereof, alcohols, in particular methanol or ethanol, or oximes are released, which are toxic and cause VOC emissions, and additionally usually contain large amounts of low molecular weight silanes, which are likewise hazardous to health. Also known are water-based polymer systems, which are usually based on acrylate dispersions or polyurethane dispersions. These cure via evaporation of water and coalescence, and are largely free of chemical reactive groups. However, they can be used only in relatively thin layers and only between open-pore substrates, the rate of curing is highly dependent on ambient humidity, and they have high shrinkage. After curing, water sensitivity is elevated because of the surfactants present, which are needed for production and stability of the dispersion, and this can lead to reduced durability, especially in outdoor applications.

### SUMMARY OF THE INVENTION

It is an object of the present invention to provide a functional polymer which is crosslinkable together with compounds having suitable reactive groups and enables room temperature curable compositions having elastic properties that overcome the disadvantages of the prior art.

This object is surprisingly achieved by a nonionic aldehyde-functional polymer as described in claim 1. The aldehyde-functional polymer of the invention that has end groups of the formula (I) is not sensitive to moisture and bubble formation, is of low toxicological concern, does not require hazard labeling and can be handled without specific precautions. The polymer of the invention is particularly suitable for crosslinking of compounds having reactive groups such as, in particular, cyanoacetate groups, 1,3-ketoester groups or malonate groups, and such a polymer system has good processibility without any need for organic solvents for dissolution or dilution, or water for emulsification or dispersion of constituents. It cures surprisingly rapidly and faultlessly under ambient conditions irrespective of humidity, without causing emissions, with very good controllability of the curing rate with customary catalysts, especially nonmetallic bases such as tertiary amines, amidines or guanidines. The curing gives rise to a nontacky elastic polymer of high strength and extensibility, and good stability to heat and water.

The polymer of the invention enables particularly high-quality elastic adhesives, sealants or coatings that overcome the disadvantages of the prior art in relation to toxic ingredients, sensitivity to moisture and stability, and robustness after curing. Further aspects of the invention are the subject of further independent claims. Particularly preferred embodiments of the invention are the subject of the dependent claims.

### WAYS OF EXECUTING THE INVENTION

The invention provides a nonionic aldehyde-functional polymer having end groups of the formula (I)

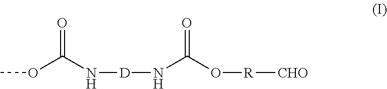

and an average content of aldehyde groups of 0.15 to 1.2 meq/g, preferably 0.2 to 0.75 meq/g, more preferably 0.2 to 0.7 meq/g, especially 0.3 to 0.6 meq/g, where
R is a divalent organic radical having 1 to 15 carbon atoms, and
D is a divalent hydrocarbyl radical having 4 to 15 carbon atoms.

A “nonionic” polymer refers to one having a content of ionic groups of less than 0.05% by weight, especially less than 0.01% by weight, based on the polymer, where the ionic groups are especially selected from carboxylate groups, ammonium groups and sulfonate groups.

“Room temperature” refers to a temperature of 23° C.

A dotted line in the formulae in this document in each case represents the bond between a substituent and the corresponding remainder of the molecule. “Molecular weight” refers to the molar mass (in grams per mole) of a molecule. “Average molecular weight” refers to the number-average molecular weight (Mₙ) of a polydisperse mixture of oligomeric or polymeric molecules. It is determined by gel-permeation chromatography (GPC) against polystyrene as standard. Substance names beginning with “poly”, such as polyol, polyisocyanate, polycyanoacetate or polyacetoacetate, refer to substances that formally contain two or more of the functional groups that occur in their name per molecule. A “storage stable” substance or composition refers to one that can be stored at room temperature in a suitable container over a prolonged period, typically over at least 3 months up to 6 months or more, without this storage resulting in any change in its application or use properties to an extent relevant to its use.

All industry standards and norms mentioned in this document relate to the versions valid at the date of first filing.

Percentages by weight (% by weight) refer to proportions by mass of a constituent of a composition or a molecule, based on the overall composition or the overall molecule, unless stated otherwise. The terms “mass” and “weight” are used synonymously in the present document.

The aldehyde-functional polymer preferably has an average molecular weight Mₙ in the range from 1500 to 20 000 g/mol, preferably 2500 to 15 000 g/mol, especially 3500 to 8000 g/mol, measured by gel permeation chromatography (GPC) versus polystyrene as standard.

Preferably, the average aldehyde functionality of the aldehyde-functional polymer is 1.8 to 4, preferably 2.0 to 3, especially 2.2 to 3.0.

Preferably, the aldehyde-functional polymer based on the overall polymer contains less than 20% by weight, especially less than 15% by weight, of oxyethylene units. Such a polymer is particularly stable to moisture.

Preferably, R, in formula (I), is a linear or branched alkyl radical, cycloalkylene radical, arylalkylene radical or aryl radical, which may also contain oxygen and/or nitrogen atoms.

In particular, the R radical is selected from the group consisting of methylene, propane-1,2-diyl, 2-methylpropane-1,2-diyl, butane-1,4-diyl, 2-oxabutane-1,4-diyl, 3-oxapentane-1,5-diyl,

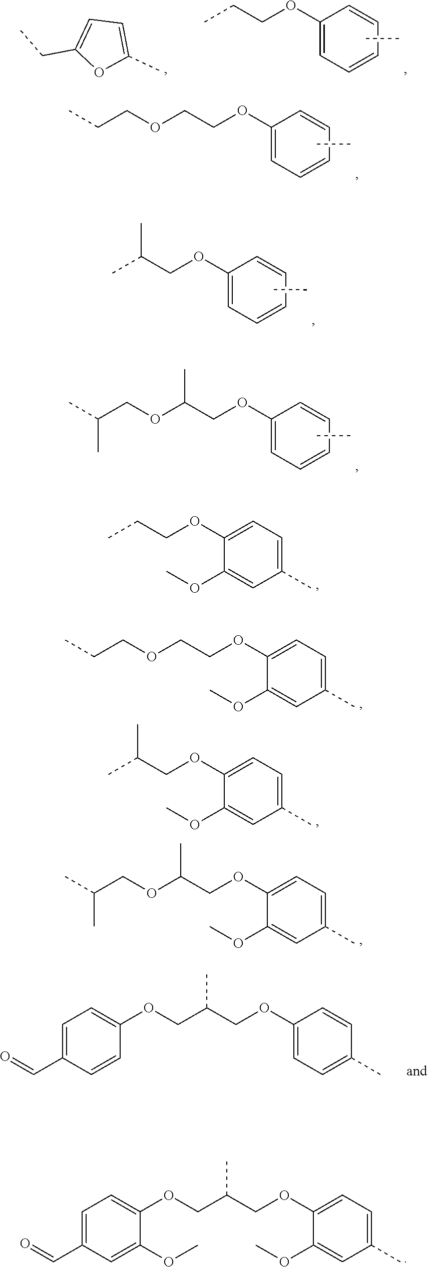

Among these, preference is given to

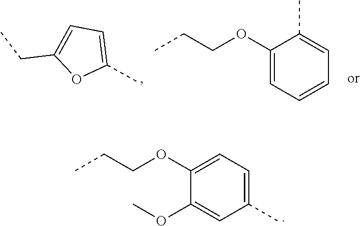

Particular preference is given to

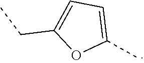

Such polymers are derived from 5-hydroxymethylfurfural, which is obtainable from renewable starting materials. These polymers are particularly low viscosity and enable curable compositions having high strength, extensibility, tear propagation resistance and resistance to heat and water.

Preferably, D in the formula (I) is the divalent radical of hexane-1,6-diamine, 2,2(4),4-trimethylhexane-1,6-diamine, 1-methyl-2,4(6)-diaminocyclohexane, isophoronediamine, 4,4′-diaminodicyclohexylmethane, diphenylmethane-4(2),4′-diamine or toluene-2,4(6)-diamine after removal of the two amino groups.

More preferably, D is the divalent radical of hexane-1,6-diamine or isophoronediamine after removal of the two amino groups, especially the radical of isophoronediamine after removal of the two amino groups. Such an aldehyde-functional polymer is of particularly low viscosity.

Preferably, R in the end groups of the formula (I) and in the compounds of the formula (II) is the same radical.

Preferably, the aldehyde-functional polymer has a polymer backbone containing poly(oxyalkylene) units and/or polyester units.

In particular, the aldehyde-functional polymer has a poly(oxyalkylene) backbone. Preferred poly(oxyalkylene) is poly(oxy-1,2-propylene), a mixed poly(oxy-1,2-propylene)(oxyethylene), poly(oxy-1,3-propylene), poly(oxy-1,4-butylene), poly(oxy-1,2-butylene) or a mixed form of these poly(oxyalkylenes). Among these, preference is given to poly(oxy-1,2-propylene), poly(oxy-1,3-propylene) or poly(oxy-1,4-butylene), especially poly(oxy-1,2-propylene), where the latter may contain a content of 0% to 25% by weight, preferably 0% to 20% by weight, of poly(oxyethylene) units based on the poly(oxyalkylene) backbone, especially at the chain ends. Aldehyde-functional polymers having such a backbone are of low viscosity and hence particularly efficiently workable and particularly hydrophobic. They enable compositions having particularly good processibility, high extensibility and good water resistance.

Preferred polymer backbones containing polyester units are esters of dicarboxylic acids and di- or triols, and triglycerides, especially esters of dimer fatty acids or derived from castor oil, the derivatives of castor oil or vegetable oils.

The aldehyde-functional polymer preferably has a content of compounds of the formula (II)

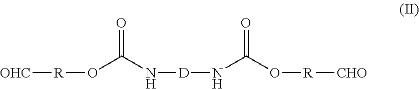

of less than 1% by weight, preferably less than 0.5% by weight, especially less than 0.2% by weight, based on the polymer, where R and D have the definitions already given. Such an aldehyde-functional polymer surprisingly enables a particularly long processing time with rapid curing and particularly high tensile strength and tear propagation resistance with high extensibility, which means that such polymer systems have particularly good processibility and are particularly robust and long-lived.

More preferably, the aldehyde-functional polymer has a poly(oxyalkylene) backbone, R is

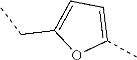

and D is the radical of isophorone diisocyanate after removal of the two isocyanate groups.

Preferably, the aldehyde-functional polymer is largely free of acid groups. It preferably has a content of acid groups of less than 0.1% by weight, based on the polymer. Such a polymer is particularly hydrophobic and enables cured compositions having good water resistance.

The aldehyde-functional polymer is preferably liquid at room temperature. In particular, it has sufficiently low viscosity to be free-flowing even without any great heating, and can thus easily be conveyed, dispensed and compounded. Preferably, the aldehyde-functional polymer has a viscosity at 20° C. of 1 to 500 Pa·s, preferably 2 to 200 Pa·s, especially 5 to 100 Pa·s, measured by cone-plate viscometer with cone diameter 10 mm, cone angle 1°, cone tip-plate distance 0.05 mm, shear rate 10 s⁻¹.

The aldehyde-functional polymer is preferably a reaction product of at least one hydroxyaldehyde of the formula HO—R—CHO with at least one polymer containing isocyanate groups.

The reaction is preferably conducted in an OH/NCO ratio of at least 1 at a temperature of 40 to 140° C., preferably 60 to 120° C., optionally in the presence of a suitable catalyst and optionally in the presence of a plasticizer.

The aldehyde-functional polymer is preferably free of isocyanate groups.

Suitable hydroxyaldehydes are especially 2-hydroxyacetaldehyde, 3-hydroxybutanal, 3-hydroxypivalaldehyde, 5-hydroxypentanal, 2-(2-hydroxyethoxy)acetaldehyde, 3-(2-hydroxyethoxy)propanal, 5-hydroxymethylfurfural, alkoxylated o- , m- or p-hydroxybenzaldehyde or alkoxylated vanillin, where “alkoxylated” preferably means (singly or multiply) “ethoxylated” or “propoxylated”, and 4,4′-(2-hydroxypropane-1,3-diyl)bis(oxy)bis(benzaldehyde) or 4,4′-(2-hydroxypropane-1,3-diyl)bis(oxy)bis(3-methoxybenzaldehyde). Preference is given to 5-hydroxymethylfurfural, ethoxylated salicylaldehyde, especially 2-(2-hydroxyethoxy)benzaldehyde, or ethoxylated vanillin, especially 4-(2-hydroxyethoxy)-3-methoxybenzaldehyde. These hydroxyaldehydes are obtainable in simple methods and enable low-viscosity aldehyde-functional polymers.

Particular preference is given to 5-hydroxymethylfurfural. This hydroxyaldehyde is obtainable from renewable starting materials and enables particularly low-viscosity polymers.

The polymer containing isocyanate groups preferably has a content of monomeric diisocyanate of the formula OCN—D—NCO of less than 0.5% by weight, preferably less than 0.2% by weight, especially less than 0.1% by weight, based on the polymer containing isocyanate groups. Such a polymer enables a particularly low content of compounds of the formula (II).

A suitable polymer containing isocyanate groups for the reaction with the hydroxyaldehyde of the formula HO—R—CHO is especially a reaction product of at least one monomeric diisocyanate of the formula OCN—D—NCO with at least one polymeric polyol in an NCO/OH ratio in the range from 3/1 to 10/1, followed by removal of the monomeric diisocyanate by a suitable separation method down to a content of less than 0.5% by weight, preferably less than 0.2% by weight, especially less than 0.1% by weight, based on the polymer.

The polymer containing isocyanate groups preferably has an NCO content in the range from 0.6% to 6% by weight, more preferably 0.9% to 3.5% by weight, especially 1.3% to 2.7% by weight, based on the polymer.

Preferably, the polymer containing isocyanate groups has an average NCO functionality of 1.8 to 4, preferably 2 to 3, especially 2.2 to 3.0.

A suitable diisocyanate of the formula OCN—D—NCO is in particular hexane 1,6-diisocyanate (HDI), 2,2(4),4-trimethylhexane 1,6-diisocyanate (TMDI), 1-methyl-2,4(6)-diisocyanatocyclohexane (H₆TDI), isophorone diisocyanate (IPDI), 4,4′-diisocyanatodicyclohexylmethane (H₁₂MDI), 4(2),4′-diphenylmethane diisocyanate (MDI) or toluene 2,4(6)-diisocyanate (TDI). Preference is given to HDI or IPDI, particular preference to IPDI.

Preferred polymeric polyols are polymers having an OH number in the range from 9 to 114 mg KOH/g, preferably 12 to 57 mg KOH/g, especially 18 to 45 mg KOH/g, and a polymer backbone containing poly(oxyalkylene) units and/or polyester units.

Particular preference is given to poly(oxyalkylene) polyols, castor oil, hydroxy-functional derivatives of castor oil, hydroxylated vegetable oils or dimer or trimer fatty acid-based polyester polyols or polyols having poly(oxyalkylene) and polyester units.

Most preferred are poly(oxyalkylene) polyols.

Preferred poly(oxyalkylene) polyols, also called polyether polyols, are especially polymerization products of ethylene oxide or 1,2-propylene oxide or 1,2-or 2,3-butylene oxide or oxetane or tetrahydrofuran or mixtures thereof, where these may be polymerized with the aid of a starter molecule having two or more active hydrogen atoms, especially a starter molecule such as water, ammonia or a compound having two or more OH or NH groups, for example ethane-1,2-diol, propane-1,2-or -1,3-diol, neopentyl glycol, diethylene glycol, triethylene glycol, the isomeric dipropylene glycols or tripropylene glycols, the isomeric butanediols, pentanediols, hexanediols, heptanediols, octanediols, nonanediols, decanediols, undecanediols, cyclohexane-1,3-or -1,4-dimethanol, bisphenol A, hydrogenated bisphenol A, 1,1, 1-trimethylolethane, 1,1,1-trimethylolpropane, glycerol or aniline, or mixtures of the aforementioned compounds.

Particular preference is given to poly(oxy-1,2-propylene) diols, poly(oxy-1,2-propylene) triols or what are called ethylene oxide-terminated (EO-endcapped or EO-tipped) poly(oxy-1,2-propylene) diols or triols. The latter are polyoxyethylene-polyoxypropylene copolyols, which are especially obtained by further alkoxylating polyoxypropylene diols or triols with ethylene oxide on conclusion of the propoxylation reaction, as a result of which they ultimately have primary hydroxyl groups.

Also particularly preferred are poly(oxy-1,3-propylene) diols or poly(oxy-1,4-butylene) diols.

Preference is given to polyols having a level of unsaturation of less than 0.02 meq/g, especially less than 0.01 meq/g.

Reaction of the monomeric diisocyanates present in the polymer containing isocyanate groups with the hydroxyaldehyde of the formula HO—R—CHO gives rise to compounds of the formula (II). A low monomeric diisocyanate content in the polymer containing isocyanate groups enables the advantageous low content of compounds of formula (II) of less than 1% by weight, preferably less than 0.5% by weight, especially less than 0.2% by weight, based on the polymer.

The aldehyde-functional polymer of the invention is particularly advantageously usable for curing of compounds having at least two reactive groups that are reactive toward aldehydes, forming cured compositions having elastic properties. The low content of compounds of the formula (II) enables a particularly long processing time with rapid curing and a particularly high tensile strength and to a tear propagation resistance with high extensibility.

The invention thus further provides for the use of the aldehyde-functional polymer for curing of at least one compound V having at least two reactive groups that are reactive toward aldehydes.

These reactive groups are preferably selected from cyanoacetate groups, 1,3-ketoester groups and malonate groups.

Compound V is preferably liquid at room temperature. In particular, it has a viscosity at 20° C. of 0.1 to 100 Pa·s, preferably 0.2 to 50 Pa·s, especially 0.5 to 20 Pa·s, measured by cone-plate viscometer with cone diameter 10 mm, cone angle 1°, cone tip-plate distance 0.05 mm, shear rate 10 s⁻¹, and with ball diameter 50 mm for viscosities of less than 1 Pa·s. Such a compound enables curable compositions having good processibility at ambient temperature and without addition of solvents or thinners.

Compound V preferably has two to four of the reactive groups mentioned.

Compound V preferably has only a low water content, especially at most 10% by weight of water based on compound V. Such a nonaqueous compound enables cured compositions having particularly good weathering stability.

Curing is preferably effected at ambient temperature, especially at a temperature in the range from −5 to 50° C., preferably 0 to 40° C.

More preferably, compound V has at least two cyanoacetate groups. This affords cured compositions having particularly good mechanical properties, especially having high extensibility and tear propagation resistance.

For curing of at least one compound V having cyanoacetate groups, the aldehyde-functional polymer is preferably used in such an amount that the ratio of the number of cyanoacetate groups to the number of aldehyde groups is in the range from 0.7 to 1.5, preferably 0.8 to 1.2, especially 0.9 to 1.1.

Particularly suitable compounds V having cyanoacetate groups are selected from ethane-1,2-diol bis(cyanoacetate), propane-1,2-diol bis(cyanoacetate), propane-1,3-diol bis(cyanoacetate), butane-1,4-diol bis(cyanoacetate), hexane-1,6-diol bis(cyanoacetate), cyclohexane-1,4-dimethanol bis(cyanoacetate), dipropylene glycol bis(cyanoacetate), 1,1,1-trimethylolpropane tris(cyanoacetate), glycerol tris(cyanoacetate), propoxylated 1,1,1-trimethylolpropane tris(cyanoacetate) having average molecular weight Mₙ of 500 to 2000 g/mol, poly(oxy-1,2-propylene) diol bis(cyanoacetate) having average molecular weight Mₙ of 2000 to 10 000 g/mol, poly(oxy-1,2-propylene) triol tris(cyanoacetate) having average molecular weight Mₙ of 2000 to 10 000 g/mol, poly(oxy-1,2-propylene) diol bis(cyanoacetate) containing ethylene oxide units and having average molecular weight Mₙ of 2000 to 10 000 g/mol, poly(oxy-1,2-propylene) triol tris(cyanoacetate) containing ethylene oxide units and having average molecular weight Mₙ of 2000 to 10 000 g/mol, dimer fatty acid-based polyesterdiol bis(cyanoacetate) having average molecular weight Mₙ of 1000 to 4000 g/mol and trimer fatty acid-based polyestertriol tris(cyanoacetate) having average molecular weight Mₙ of 1000 to 4000 g/mol.

Such compounds V having cyanoacetate groups are especially obtained from the transesterification of at least one cyanoacetate of the formula (III)

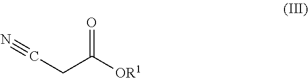

where R¹ is C₁₋₆ alkyl with at least one polyfunctional alcohol, with release and removal of the alcohol of the formula R¹—OH.

Preferably, R¹ here is methyl, ethyl or tert-butyl, especially ethyl.

Further preferably, compound V has at least two 1,3-ketoester groups, preferably at least two 1,3-ketoester groups of the formula (IV), especially at least two acetoacetate groups.

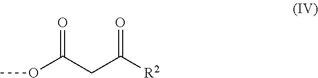

In formula (IV), R² is a monovalent hydrocarbyl radical having 1 to 6 carbon atoms, preferably methyl, ethyl, propyl, isopropyl, butyl or phenyl, especially methyl. For curing of at least one compound V having 1,3-ketoester groups, the aldehyde-functional polymer is preferably used in such an amount that the ratio of the number of 1,3-ketoester groups to the number of aldehyde groups is in the range from 0.5 to 2.5, more preferably 0.8 to 2.2, especially 1 to 2.

Particularly suitable compounds V having 1,3-ketoester groups are selected from ethane-1,2-diol bis(acetoacetate), propane-1,2-diol bis(acetoacetate), propane-1,3-diol bis(acetoacetate), butane-1,4-diol bis(acetoacetate), hexane-1,6-diol bis(acetoacetate), cyclohexane-1,4-dimethanol bis(acetoacetate), dipropylene glycol bis(acetoacetate), 1,1,1-trimethylolpropane tris(acetoacetate), glycerol tris(acetoacetate), propoxylated 1,1,1-trimethylolpropane tris(acetoacetate) having average molecular weight Mₙ of 500 to 2000 g/mol, poly(oxy-1,2-propylene) diol bis(acetoacetate) having average molecular weight Mₙ of 600 to 10 000 g/mol, poly(oxy-1,2-propylene) triol tris(acetoacetate) having average molecular weight Mₙ of 2000 to 10 000 g/mol, poly(oxy-1,2-propylene) triol tris(acetoacetate) containing ethylene oxide units and having average molecular weight Mₙ of 2000 to 10 000 g/mol, dimer fatty acid-based polyester diol bis(acetoacetate) and trimer fatty acid-based polyester triol tris(acetoacetate).

Such compounds V having 1,3-ketoester groups are especially obtained from the transesterification of at least one 1,3-ketoester of the formula (V)

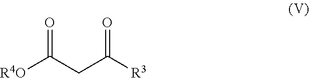

where R³ is a monovalent hydrocarbyl radical having 1 to 6 carbon atoms and R⁴ is C₁₋₆ alkyl
   with at least one polyfunctional alcohol, with release and removal of the alcohol of the formula R⁴OH.

Preferably, R³ is methyl, ethyl, propyl, isopropyl, butyl or phenyl, preferably methyl or phenyl, especially methyl, and R⁴ is methyl, ethyl or tert-butyl, especially ethyl. Compounds V having 1,3-ketoester groups are also obtained by reaction of diketene or the adduct of diketene with acetone (=2,2,6-trimethyl-4H-1,3-dioxin-4-one) with at least one polyfunctional alcohol, with release of acetone in the case of the acetone-diketene adduct.

Further preferably, compound V has at least two malonate groups, especially malonate groups of the formula

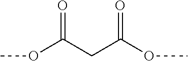

For curing of at least one compound V having malonate groups, the aldehyde-functional polymer is preferably used in such an amount that the ratio of the number of malonate groups to the number of aldehyde groups is in the range from 0.5 to 2.5, more preferably 0.8 to 2.2, especially 1 to 2.

Particularly suitable compounds V having malonate groups are selected from ethane-1,2-diol bis(ethylmalonate), propane-1,2-diol bis(ethylmalonate), propane-1,3-diol bis(ethylmalonate), butane-1,4-diol bis(ethylmalonate), hexane-1,6-diol bis(ethylmalonate), cyclohexane-1,4-dimethanol bis(ethylmalonate), diethylene glycol bis(ethylmalonate), dipropylene glycol bis(ethylmalonate), glycerol tris(ethylmalonate), 1,1,1-trimethylolpropane tris(ethylmalonate), dimer fatty acid diol bis(ethylmalonate), trimer fatty acid triol tris(ethylmalonate), castor oil tris(ethylmalonate), poly(oxy-1,2-propylene) diol bis(ethylmalonate) having an average molecular weight Mₙ of 500 to 2000 g/mol, propoxylated 1,1,1-trimethylolpropane having three ethylmalonate end groups and an average molecular weight Mₙ of 650 to 2500 g/mol, corresponding oligomeric compounds of these reaction products and polyester diols containing malonate groups from the reaction of diols such as hexane-1,6-diol or cyclohexane-1,4-dimethanol with malonic acid or diethyl malonates and optionally further dicarboxylic acids or esters thereof, such as, in particular, adipic acid or diethyl adipate or dimer fatty acids.

Suitable compounds V having malonate groups are especially obtained from the reaction of at least one polyfunctional alcohol with malonic acid or at least one malonate of the formula (VI)

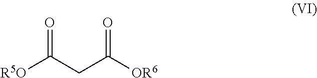

where R⁵ and R⁶ are each an alkyl radical having 1 to 6 carbon atoms. Preferably, R⁵ and R⁶ are each methyl, ethyl or isopropyl, especially ethyl. A preferred malonate of the formula (VI) is dimethyl malonate, diethyl malonate, diisopropyl malonate, butyl ethyl malonate, tert-butyl ethyl malonate or di-tert-butyl malonate. Particular preference is given to dimethyl malonate, diethyl malonate or diisopropyl malonate, especially diethyl malonate.

Suitable polyfunctional alcohols for reaction with cyanoacetates of the formula (III) or 1,3-ketoesters of the formula (V) or malonates of the formula (VI) are commercial compounds or polymers having two or more OH groups, such as, in particular, ethane-1,2-diol, propylene glycol, butane-1,4-diol, pentane-1,5-diol, hexane-1,6-diol, cyclohexane-1,3-dimethanol, cyclohexane-1,4-dimethanol, diethylene glycol, dipropylene glycol, 1,1,1-trimethylolpropane, glycerol, ethoxylated or especially propoxylated glycerol, ethoxylated or especially propoxylated 1,1,1-trimethylolpropane, castor oil, ethoxylated or especially propoxylated castor oil, ketone resin-modified castor oil, poly(oxy-1,2-propylene) diols or triols, ethylene oxide-endcapped poly(oxy-1,2-propylene) diols or triols, dimer fatty acid diols or trimer fatty acid triols or dimer or trimer fatty acid-based polyester diols or triols.

Also obtainable are compounds V having malonate groups from the reaction of malonic acid with polyfunctional alcohols having an excess of OH groups. The stoichiometry here in the reaction is preferably in the range from 2.2 to 3.5, preferably 2.3 to 3.3, molar equivalents of OH groups of the polyfunctional alcohol per mole of malonic acid. In this reaction, it is especially also possible to use further dicarboxylic acids, for example adipic acid.

Likewise possible are compounds V having mixed reactive groups, i.e., for example, a compound V having at least one cyanoacetate group and at least one acetoacetate group, or having at least one cyanoacetate group and at least one malonate group, or having at least one acetoacetate group and at least one malonate group.

Preference is given to using the aldehyde-functional polymer for curing of at least one compound V as a constituent of a two-component composition, where the first component contains the aldehyde-functional polymer of the invention and the second component contains compound V, where the first and second component are storage-stable on their own and are stored in separate containers until they are mixed with one another shortly before or during application.

The two-component composition may additionally contain further constituents, especially fillers, fibers, nanofillers such as graphene or carbon nanotubes, dyes, pigments, plasticizers, solvents, rheology modifiers, adhesion promoters such as, in particular, titanates or organoalkoxysilanes, catalysts, especially nonmetallic bases such as tertiary amines, amidines or guanidines, or basic salts such as, in particular, potassium acetate, potassium benzoate, potassium carbonate or sodium acetate, especially as an aqueous solution, or flame-retardant substances, additives such as, in particular, wetting agents, leveling agents, defoamers, deaerating agents or stabilizers against oxidation, heat, light or UV radiation, or other substances that are customarily used in curable compositions. Such additions may be present as constituents of the first or of the second component. Substances reactive with aldehyde groups are preferably a constituent of the second component.

The composition preferably additionally contains at least one further constituent selected from plasticizers, fillers and catalysts. In particular, it comprises several such further constituents.

The composition preferably contains less than 10% by weight, more preferably less than 5% by weight, especially less than 1% by weight, of volatile organic solvents having a boiling point at standard pressure of less than 250° C., based on the overall composition. Such a composition causes a particularly low level of emissions.

The consistency of the first and second components is suitably such that the components can be mixed efficiently with one another by simple methods under ambient conditions. For this purpose, liquid or pasty components in particular are suitable.

For application, the two components and any further components present are mixed with one another shortly before or during the application. The mixing ratio is chosen here such that the ratio of the reactive groups is within a suitable range. In parts by weight, the mixing ratio between the first and second components is typically in the range from about 100:1 to 1:5, especially 50:1 to 1:2.

If the components are mixed with one another prior to application, it must be ensured that not too much time passes between the mixing of the components and the application, since the onset of reaction and the associated rise in viscosity can otherwise lead to problems, for example inadequate leveling or delayed or incomplete adhesion to the substrate.

“Processing time” refers here to the time span between the mixing of the components and the end of a state of the composition suitable for processing. A long processing time is particularly advantageous in the case of subsequently rapid curing.

Mixing and curing are preferably effected at ambient temperature.

The mixing of the two components commences curing of the composition via the onset of chemical reaction. It is mainly the aldehyde groups that react here with the reactive groups present in compound V, which ultimately cures the composition to give a solid polymeric material.

In the case of cyanoacetate groups as reactive groups of compound V, the curing reaction can be expected to form structural units of the formula

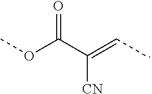

In the case of 1,3-ketoester groups as reactive groups of compound V, the curing reaction can be expected to form structural units of the formula

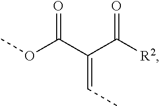

where any other 1,3-ketoester group present can add on to the C═C double bond formed and hence increase the crosslinking density.

In the case of malonate groups as reactive groups of compound V, the curing reaction can be expected to form structural units of the formula

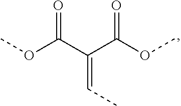

where any other malonate group present can add on to the C═C double bond formed and hence increase the crosslinking density.

In particular, the curing affords an elastic material having a tensile strength of at least 1 MPa, preferably at least 2 MPa, and an elongation at break of at least 50%, preferably at least 100%, more preferably at least 200%, especially at least 400%, determined to DIN EN 53504 at a strain rate of 200 mm/min.

The aldehyde-functional polymer of the invention, having end groups of the formula (I), enables a particularly long processing time with rapid curing and particularly high tensile strength and tear propagation resistance with high extensibility, which means that such polymer systems have particularly good processibility and are particularly robust and long-lived.

The aldehyde-functional polymer of the invention is particularly suitable as a constituent of elastic adhesives, sealants or coatings that are largely free of toxic ingredients and not very sensitive to moisture, and, after curing, have high stability and robustness.

### EXAMPLES

Working examples are adduced hereinafter, which are intended to further elucidate the invention described. It will be apparent that the invention is not limited to these described working examples.

“Standard climatic conditions” (“SCC”) refer to a temperature of 23±1° C. and a relative atmospheric humidity of 50±5%.

The chemicals used were from Sigma-Aldrich Chemie GmbH, unless stated otherwise.

### Description of the Measurement Methods

Monomeric diisocyanate content was determined by means of HPLC (detection via photodiode array; 0.04 M sodium acetate/acetonitrile as mobile phase) after prior derivation by means of N-propyl-4-nitrobenzylamine.

Viscosity was measured on a thermostated Rheotec RC30 cone-plate viscometer (cone diameter 10 mm, cone angle 1°, cone tip-plate distance 0.05 mm, shear rate 10s⁻¹). Viscosities of less than 1 Pa·s were measured with a cone diameter of 50 mm.

Infrared spectra (FT-IR) were measured as undiluted films on a Nicolet iS5 FT-IR instrument from Thermo Scientific equipped with a horizontal ATR measurement unit with a diamond crystal. Absorption bands are reported in wavenumbers (cm⁻¹).

### Preparation of Polymers Containing Isocyanate Groups

### Polymer NCO-1:

780 g of ethylene oxide-terminated polyoxypropylene triol (Desmophen® 5031 BT, OH number 28.0 mg KOH/g, from Covestro) and 303 g of isophorone diisocyanate (Vestanat® IPDI, from Evonik) were converted at 80° C. by a known method to a reaction mixture having an NCO content of 9.1% by weight. Subsequently, the volatile constituents, in particular unconverted isophorone diisocyanate, were removed by distillation in a short-path evaporator (jacket temperature 160° C., pressure 0.1 to 0.005 mbar) to obtain a polymer having an NCO content of 1.84% by weight and a monomeric isophorone diisocyanate content of 0.02% by weight.

### Polymer NCO-2:

894.5 g of ethylene oxide-terminated polyoxypropylene triol (Desmophen® 5031 BT, OH number 28.0 mg KOH/g, from Covestro) and 102.0 g of isophorone diisocyanate (Vestanat® IPDI, from Evonik) were converted in the presence of 0.01 g of dibutyltin dilaurate by a known method at 80° C. to a polymer having an NCO content of 1.83% by weight and a monomeric isophorone diisocyanate content of 1.4% by weight.

### Polymer NCO-3:

590 g of polyoxypropylene diol (Acclaim® 4200, OH number 28 mg KOH/g, from Covestro), 1180 g of ethylene oxide-terminated polyoxypropylene triol (Caradol® MD34-02, OH number 35 mg KOH/g, from Shell) and 230 g of isophorone diisocyanate (Vestanat® IPDI, from Evonik) were converted at 80° C. by a known method to a polymer having an NCO content of 2.1% by weight and a monomeric isophorone diisocyanate content of 1.3% by weight.

### Polymer NCO-4:

818 g of polyoxypropylene diol (Acclaim® 4200, OH number 28.5 mg KOH/g, from Covestro) and 227 g of isophorone diisocyanate (Vestanat® IPDI, from Evonik) were converted at 80° C. by a known method to a reaction mixture having an NCO content of 6.6% by weight. Subsequently, the volatile constituents, in particular unconverted isophorone diisocyanate, were removed by distillation in a short-path evaporator (jacket temperature 160° C., pressure 0.1 to 0.005 mbar) to obtain a polymer having an NCO content of 1.91% by weight and a monomeric isophorone diisocyanate content of 0.03% by weight.

### Polymer NCO-5:

600 g of polyoxypropylene diol (Voranol® 1010 L, OH number 112 mg KOH/g, from Dow) and 533.3 g of isophorone diisocyanate (Vestanat® IPDI, from Evonik) were converted at 80° C. by a known method to a reaction mixture having an NCO content of 15.6% by weight. Subsequently, the volatile constituents, in particular unconverted isophorone diisocyanate, were removed by distillation in a short-path evaporator (jacket temperature 160° C., pressure 0.1 to 0.005 mbar) to obtain a polymer having an NCO content of 5.18% by weight and a monomeric isophorone diisocyanate content of 0.03% by weight.

### Polymer NCO-6:

150 g of polyoxypropylene diol (Voranol® P400, OH number 263 mg KOH/g, from Dow) and 156.4 g of isophorone diisocyanate (Vestanat® IPDI, from Evonik) were converted at 80° C. by a known method to a reaction mixture having an NCO content of 9.65% by weight and a monomeric isophorone diisocyanate content of >1% by weight.

### Preparation of Aldehyde-Functional Polymers

### Polymers A-1 to A-8:

For each of the compounds, the amounts specified in table 1 (in parts by weight) of the corresponding polymer containing isocyanate groups were reacted, in the presence of 0.02% by weight of dibutyltin dilaurate, with exclusion of moisture at 110° C., with the specified amount (in parts by weight) of the corresponding hydroxy-functional aldehyde until no isocyanate groups were detectable any longer by IR spectroscopy.

TABLE 1
Preparation and properties of polymers A-1 to A-8.

| | | | | | | | | A-8 |
|---|---|---|---|---|---|---|---|---|
| Polymer | A-1 | A-2 | A-3 | A-4 | A-5 | A-6 | A-7 | (Ref.) |
| Polymer NCO-1 | 500.0 | — | — | — | 500.0 | 500.0 | — | — |
| Polymer NCO-2 | | 500.0 | | — | — | — | — | — |
| Polymer NCO-3 | — | — | 500.0 | — | — | — | — | — |
| Polymer NCO-4 | — | — | — | 500.0 | — | — | — | — |
| Polymer NCO-5 | — | — | — | — | — | — | 500.0 | — |
| Polymer NCO-6 | | | | | | — | — | 300.0 |
| 5- | 27.7 | 27.7 | 31.5 | 28.9 | — | — | 77.8 | 88.6 |
| Hydroxymethylfurfural | | | | | | | | |
| 2-(2-Hydroxyethoxy)- | — | — | — | — | 37.4 | — | — | — |
| benzaldehyde | | | | | | | | |
| Vanillin-dialdehyde ¹ | — | — | — | — | — | 78.9 | — | — |
| Viscosity (20° C.) [Pa · s] | 63.7 | 238.0 | 111.7 | 33.2 | 138.3 | 1050 | 438.0 | solid |
| Content of compounds | 0.04 | 2.8 | 2.6 | 0.05 | 0.05 | 0.08 | 0.06 | >2 |
| (II) [% by wt.] | | | | | | | | |
| Aldehyde group | 0.42 | 0.42 | 0.47 | 0.43 | 0.42 | 0.76 | 1.07 | 1.80 |
| content [meq/g] | | | | | | | | |
| Aldehyde equivalent | 2381 | 2381 | 2128 | 2326 | 2381 | 1322 | 937 | 553 |
| weight [g/eq] | | | | | | | | |

¹ 4,4′-(2-hydroxypropane-1,3-diyl)bis(oxy)bis(3-methoxybenzaldehyde), prepared from 2 mol of vanillin and 1 mol of epichlorohydrin

The average molecular weight Mₙ of polymer A-1 was additionally determined by gel permeation chromatography (GPC) versus polystyrene (474 to 2 520 000 g/mol) as standard with tetrahydrofuran as mobile phase and refractive index detector. The average molecular weight Mₙ was 6100 g/mol.

Polymer A-8, labelled “(Ref.)”, is a comparative example having an average content of aldehyde groups of 1.07 meq/g, i.e. outside the range claimed. It was a glassy solid at room temperature and was therefore not used for production of a curable composition.

### Production of Compounds Having at Least Two Reactive Groups

### Compound V-1: (Having Cyanoacetate Groups)

To 50.0 g of trimethylolpropane-started poly(oxy-1,2-propylene) triol (Desmophen® 4011 T, OH number 550 mg KOH/g, from Covestro) were added 61.0 g of ethyl cyanoacetate and 0.1 g of tetra-n-butyl titanate (Tyzor® TnBT, from Dorf Ketal), and the mixture was converted at a temperature of 140° C. under reduced pressure and with distillative removal of ethanol. What was obtained was a clear, colorless liquid having a viscosity at 20° C. of 1.72 Pa·s, a cyanoacetate functionality of 3 and a calculated cyanoacetate equivalent weight of 169 g/eq.

### Compound V-2: (Having Acetoacetate Groups)

To 50.0 g of trimethylolpropane-started poly(oxy-1,2-propylene) triol (Desmophen® 4011 T, OH number 550 mg KOH/g, from Covestro) were added 67.0 g of ethyl acetoacetate and 0.1 g of tetra-n-butyl titanate (Tyzor® TnBT, from Dorf Ketal), and the mixture was converted at a temperature of 140° C. under reduced pressure and with distillative removal of ethanol. What was obtained was a clear, colorless liquid having a viscosity at 20° C. of 0.8 Pa.s, a acetoacetate functionality of 3 and a calculated acetoacetate equivalent weight of 186 g/eq.

### Compound V-3: (Having Malonate Groups)

To 123.4 g of trimethylolpropane-started poly(oxy-1,2-propylene) triol (Desmophen® 4011 T, OH number 550 mg KOH/g, from Covestro) were added 192.2 g of diethyl malonate and 0.3 g of tetra-n-butyl titanate (Tyzor® TnBT, from Dorf Ketal), and the mixture was converted at a temperature of 140° C. under reduced pressure and with distillative removal of ethanol. What was obtained was a clear, colorless liquid having a viscosity at 20° C. of 7.3 Pa·s, an estimated malonate functionality of about 3 and an estimated malonate equivalent weight of about 217 g/eq.

### Production of Curable Compositions

### Compositions Z-1 to Z-10

For each example, the ingredients of the first component (K1) that are specified in tables 2 and 3 were mixed in the specified amounts (in parts by weight) using a centrifugal mixer (SpeedMixer™ DAC 150, FlackTek Inc.) and stored in a closed container.

The ingredients of the second component (K2) that are specified in tables 2 and 3 were likewise processed and stored.

The “precipitated CaCO₃” used was Socal® U1S2 (from Imerys), a precipitated and stearate-coated calcium carbonate.

The “carbon black” used was Monarch® 570 (from Cabot).

The two components of each composition were then processed to afford a homogeneous liquid using the centrifugal mixer and said liquid was immediately tested as follows:

Gel time was determined by stirring a freshly mixed amount of about 3 g under standard climatic conditions with a spatula at regular intervals until this was no longer possible as a result of gelation of the mass.

Mechanical properties were determined by applying the mixed composition to a silicone-coated release paper to give a film of thickness 2 mm, leaving the film to cure under standard climatic conditions for 7 days, punching a few dumbbell-shaped test specimens having a length of 75 mm with a bar length of 30 mm and a bar width of 4 mm out of the film and testing these in accordance with DIN EN 53504 at a strain rate of 200 mm/min for Tensile strength, Elongation at break, and modulus of elasticity MoE 5% (at 0.5%- 5% elongation) and MoE 50% (at 0.5%- 50% elongation). Furthermore, a number of test specimens were punched out for determination of Tear propagation resistance and were tested in accordance with DIN ISO 34-1, Method B (angular test specimens) at a strain rate of 500 mm/min.

Shore A hardness was determined to DIN 53505 on test specimens cured under standard climatic conditions for 7 days. These results are given the addition “7 d SCC”. For some compositions, Shore A hardness was also determined after curing for 1 day, 2 days and 4 days, and identified accordingly. Resistance to heat and water was determined for some compositions by storing further Shore A test specimens, after curing under standard climatic conditions for 7 days, either additionally in an air circulation oven at 100° C. for 7 days or additionally at 70° C. and 100% relative humidity for 7 days, cooling them down to room temperature and then determining Shore A hardness as described in each case. These results are given the addition “+7 d 100° C.” or “+7 d 70/100”.

Curing in each case gave a nontacky, elastic material.

The results are reported in Tables 2 and 3.

TABLE 2
Composition and properties of Z-1 to Z-3.

| Composition | Z-1 | Z-2 | Z-3 |
|---|---|---|---|
| Component K1: | | | |
| Polymer | A-1 | A-2 | A-3 |
| | 30.0 | 30.0 | 30.0 |
| Diisodecyl phthalate | 20.0 | 20.0 | 20.0 |
| Precipitated CaCO₃ | 30.0 | 30.0 | 30.0 |
| Carbon black | 10.0 | 10.0 | 10.0 |
| DAEE ¹ | 0.1 | 0.1 | 0.1 |
| DMDEE ² | 0.9 | 0.9 | 0.9 |
| Component K2: | | | |
| Compound V-1 | 3.01 | 3.01 | 3.41 |
| Gel time [min] | 20 | 9 | 12 |
| Tensile strength [MPa] | 6.7 | 4.1 | 5.9 |
| Elongation at break [%] | 686 | 769 | 536 |
| MoE 5% [MPa] | 2.1 | 1.1 | 2.8 |
| MoE 50% [MPa] | 1.3 | 0.6 | 1.6 |
| Tear propagation resistance | 16.5 | 15.1 | 13.4 |
| [N/mm] | | | |
| Shore A (1 d SCC) | 40 | 27 | 44 |
| (2 d SCC) | 41 | 28 | 45 |
| (4 d SCC) | 42 | 29 | 48 |
| (7 d SCC) | 43 | 31 | 50 |
| (+7 d 100° C.) | 55 | n.d. | n.d. |
| (+7 d 70/100) | 42 | n.d. | n.d. |

¹ 2,2′-bis(dimethylamino)diethyl ether
² 2,2′-dimorpholinodiethyl ether

It is apparent from table 2 that composition Z-1 comprising polymer A-1 with only 0.04% by weight of compound of the formula (II) has a longer processing time with rapid curing and higher tensile strength and tear propagation resistance with high extensibility by comparison with compositions Z-2 and Z-3 comprising polymers A-5 2 and A-3, which have a high content of compound of the formula (II) at 2.8% and 2.6% by weight respectively.

TABLE 3
Composition and properties of Z-4 to Z-10.

| Composition | Z-4 | Z-5 | Z-6 | Z-7 | Z-8 | Z-9 | Z-10 |
|---|---|---|---|---|---|---|---|
| Component K1: | | | | | | | |
| Polymer | A-1 | A-4 | A-4 | A-5 | A-5 | A-6 | A-7 |
| | 30.0 | 30.0 | 30.0 | 30.0 | 30.0 | 30.0 | 30.0 |
| Diisodecyl phthalate | 20.0 | 20.0 | 20.0 | 20.0 | 20.0 | 20.0 | 20.0 |
| Precipitated | 30.0 | 30.0 | 30.0 | 30.0 | 30.0 | 30.0 | 30.0 |
| CaCO₃ | | | | | | | |
| Carbon black | 10.0 | 10.0 | 10.0 | 10.0 | 10.0 | 10.0 | 10.0 |
| DAEE ¹ | — | — | — | — | 0.1 | 0.1 | 0.1 |
| DMDEE ² | — | — | — | — | 0.9 | 0.9 | 0.9 |
| DBU ³ | 0.3 | 0.6 | 0.3 | 0.3 | — | — | — |
| Component K2: | | | | | | | |
| Compound V-1 | — | | — | — | 3.01 | 5.29 | 6.80 |
| Compound V-2 | 3.62 | — | 3.51 | 3.38 | — | — | — |
| Compound V-3 | — | 5.06 | — | — | — | — | — |
| Gel time [min] | 15 | 5 | 15 | 40 | 25 | 25 | 20 |
| Tensile strength | 3.3 | 4.0 | 2.0 | 3.8 | 6.7 | 6.2 | 3.1 |
| [MPa] | | | | | | | |
| Elongation at break | 157 | 144 | 120 | 164 | 605 | 146 | 536 |
| [%] | | | | | | | |
| MoE 5% [MPa] | 3.9 | 4.5 | 3.3 | 5.0 | 1.7 | 7.5 | 1.3 |
| MoE 50% [MPa] | 2.2 | 2.7 | 2.1 | 2.4 | 1.2 | 6.2 | 0.6 |
| Tear propagation | 3.8 | 3.3 | 3.7 | n.d. | n.d. | 5.3 | 7.9 |
| resistance [N/mm] | | | | | | | |
| Shore A (7 d SCC) | 54 | 60 | 51 | 59 | 46 | 68 | 29 |
| (+7 d 100° C.) | 59 | 53 | n.d. | n.d. | 53 | 73 | 62 |
| (+7 d 70/100) | 53 | 48 | n.d. | n.d. | 41 | 54 | 34 |

“n.d.” stands for “not determined”
¹ 2,2′-bis(dimethylamino)diethyl ether
² 2,2′-dimorpholinodiethyl ether
³ 1,8-diazabicyclo[5.4.0]undec-7-ene (Lupragen ® N700, from BASF)

1. A nonionic aldehyde-functional polymer having end groups of the formula (I) 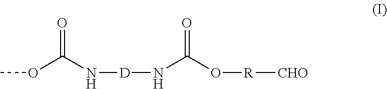
and an average content of aldehyde groups of 0.15 to 1.2 meq/g,
where
R is a divalent organic radical having 1 to 15 carbon atoms, and
D is a divalent hydrocarbyl radical having 4 to 15 carbon atoms.

2. The aldehyde-functional polymer as claimed in claim 1, wherein the average molecular weight Mₙ is in the range from 1500 to 20 000 g/mol, measured by gel permeation chromatography (GPC) versus polystyrene as standard.

3. The aldehyde-functional polymer as claimed in claim 1, wherein the average aldehyde functionality is 1.8 to 4.

4. The aldehyde-functional polymer as claimed in claim 1, wherein R is a linear or branched alkylene radical, cycloalkylene radical, arylalkylene radical or aryl radical, which may also contain oxygen and/or nitrogen atoms.

5. The aldehyde-functional polymer as claimed in claim 1, wherein D is the divalent radical of hexane-1,6-diamine, 2,2(4),4-trimethylhexane-1,6-diamine, 1-methyl-2,4(6)-diaminocyclohexane, isophoronediamine, 4,4′-diaminodicyclohexylmethane, diphenylmethane-4(2),4′-diamine or toluene-2,4(6)-diamine after removal of the two amino groups.

6. The aldehyde-functional polymer as claimed in claim 1, wherein it has a polymer backbone containing poly(oxyalkylene) units and/or polyester units.

7. The aldehyde-functional polymer as claimed in claim 1, wherein it has a content of compounds of the formula (II) 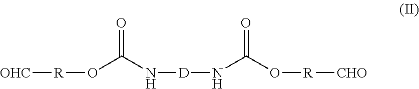
of less than 1% by weight, based on the polymer.

8. The aldehyde-functional polymer as claimed in claim 1, wherein it has a content of acid groups of less than 0.1% by weight, based on the polymer.

9. The aldehyde-functional polymer as claimed in claim 1, wherein it has a viscosity at 20° C. of 1 to 500 Pa·s, measured by cone-plate viscometer with cone diameter 10 mm, cone angle 1°, cone tip-plate distance 0.05 mm, shear rate 10 s⁻¹.

10. The aldehyde-functional polymer as claimed in claim 1, wherein it is a reaction product of at least one hydroxyaldehyde of the formula HO—R—CHO with at least one polymer containing isocyanate groups.

11. The aldehyde-functional polymer as claimed in claim 10, wherein the polymer containing isocyanate groups is a reaction product of at least one monomeric diisocyanate of the formula OCN—D—NCO with at least one polymeric polyol in an NCO/OH ratio in the range from 3/1 to 10/1, followed by removal of the monomeric diisocyanate by a suitable separation method down to a content of less than 0.5% by weight, based on the polymer containing isocyanate groups.

12. The aldehyde-functional polymer as claimed in claim 11, wherein the polymeric polyol is a polymer having an OH number in the range from 9 to 114 mg KOH/g, and a polymer backbone containing poly(oxyalkylene) units and/or polyester units.

13. A method comprising using the aldehyde-functional polymer as claimed in claim 1 to cure at least one compound V having at least two reactive groups that are reactive toward aldehydes.

14. The method as claimed in claim 13, wherein the curing is effected at ambient temperature.

15. The method as claimed in claim 13, wherein the curing affords an elastic material having a tensile strength of at least 1 MPa, and an elongation at break of at least 50%, determined to DIN EN 53504 at a strain rate of 200 mm/min.
